(19) United States
(12) Patent Application Publication
(10) Pub. No.: US 2025/0153584 A1
(43) Pub. Date: May 15, 2025

(54) Positioning mechanism of a landing pad with integral flexible connectors for communication and charging UAVs

(71) Applicant: STRIX DRONES LTD, Neve Yarak (IL)

(72) Inventors: Niv Aharoni, Neve Yarak (IL); Maoz Klein, Tel Aviv (IL)

(73) Assignee: STRIX DRONES LTD, Neve Yarak (IL)

(21) Appl. No.: 18/509,328

(22) Filed: Nov. 15, 2023

(51) Int. Cl. B60L 53/16; B60L 53/30; B64F 1/36; B64U 70/97

(52) U.S. Cl. CPC B60L 53/16; B60L 53/30; B64F 1/362; B64U 70/97; B60L 2200/10

(57) ABSTRACT

A charging and communication method and system between an unmanned aerial vehicle UAV to a landing platform that includes a charging system for charging a battery of the UAV by a power supply source, aid a communication system to electrically connect a computing unit in the landing platform with a controller of the UAV. The charging system comprises a positive and negative outlet charging connectors with flexible springy conductive elements, and a positive and negative inlet charging connectors. The inlet connectors are assembled on the landing gears of the UAV and the outlet connectors are assembled on the pushers of a positioning mechanism of the landing platform. The communication system includes an inlet communication connector that is assembled on the landing gear of the UAV and an outlet communication connector that is assembled on the pusher of the positioning mechanism.

### TECHNICAL FIELD

The present invention relates to Flexible and springy charging and communication system for UAVs.

### PRIOR ART

The use of unmanned aerial vehicles is increasing from time to time, that requires innovations and solutions for charging and communication between the unmanned aerial vehicle and their landing platforms or their docking stations. In particular: (a) charging the battery of the UAV at a relatively high current in the short time; (b) transmission of communication between the station to the UAV, which is more efficient with very small communication connectors with small diameter of the pins and small distances between the; (c) a reliable connection (reciprocating, infrequent, permanent) between the station and the UAV in a tolerant manner that allows all types of UAVs to use it. The present invention discloses and good and efficient solution for these needs.

### BRIEF DESCRIPTION OF THE FIGURES

FIG. 1 is a schematic illustration of the charging and communication system (100) that comprises the charging system (400) and the communication system (500).

FIG. 2 depicts the landing platform (300).

FIG. 3 depicts the UAV.

FIGS. 4A and 4B depict the landing gears (203-1) (203-2) with the positive and the negative inlet charging connector (402-1)(402-2).

FIG. 5 depicts the landing gear (203-3) with the inlet communication connector (502).

FIGS. 6 and 7 depict the pushers.

FIGS. 8A and 8B are a perspective depiction of the outlet charging connectors.

FIG. 9A is a top view depiction of the outlet charging connector.

FIG. 9B is a schematic illustration of the part of the element that touches the inlet connector.

FIG. 10 is a perspective depiction of the outlet communication connector.

FIG. 11 is a depiction of the outlet communication connector with four springs (66).

### THE INVENTION

The main objective of the present invention is to provide a charging and communication system (100) between an unmanned aerial vehicle UAV (200) to a landing platform (300). The charging and communication system comprises a charging system (400) that is designed to charge a battery (201) of the UAV by a power supply source (301), and a communication system (500) that is deigned to electrically connect a computing unit (302) in the landing platform with a controller (202) of the UAV. The present intention also refers to the charging system (400) separately, and also to communication system (500) separately from the charging and communication system (100).

The charging system comprises a positive outlet charging connector (401-1), a negative outlet charging connector (401-2), a positive inlet charging connector (402-1), a negative outlet charging connector (402-2). The positive outlet charging connector corresponds with the positive inlet charging connector and the negative outlet charging connector corresponds with the negative inlet charging connector.

The positive inlet charging connector is assembled on a first landing gear (203-1) of the UAV and the negative inlet charging connector is assembled on the first landing gear or on a second landing gear (203-2) of the UAV. The positive outlet charging connector is assembled on a first pusher (303-1) of a positioning mechanism (304) of the landing platform and the negative outlet charging connector is assembled on the first pusher (303-1) or on a second pusher (303-2) of the positioning mechanism. In general, the positive outlet charging connector may be similar or identical to the negative outlet charging connector, and the positive inlet charging connector can be similar or identical to the negative outlet charging connector.

The communication system comprises an outlet communication connector (501) and an inlet communication connector (502). The outlet communication connector corresponds with the inlet communication connector. The inlet communication connector is assembled on a landing gear (203-3) of the UAV and the outlet communication connector is assembled on a pusher (303-3) of a positioning mechanism.

In other words, these inlet connectors should be mounted on the same part of the UAV that constitutes the gears of the UAV when landing, that is leveled with the pushers, and we use the phrase “landing gears” for illustration only. It is possible to assemble these inlet connectors on the same landing gear or on an adjacent landing gear, or any other gear, provided that the corresponding outlet connectors are connected to the proper pushers.

When implementing the invention on a specific UAV and corresponding landing platform, the UAV should be positioned on the landing platform in a predetermined position by the positioning mechanism, so that the positive outlet charging connector (assembled on the pusher) is adjacent to the positive inlet charging connector (assembled on the gear), the negative outlet charging connector (assembled on the pusher) is adjacent to the negative inlet charging connector (assembled on the gear), and the outlet communication connector (assembled on the pusher) is adjacent to the inlet communication connector (assembled on the gear).

In the embodiment described above, the important aspect is that the connectors are mounted respectively on the landing gears and the pushers and that they match each other, for creating the electrical connection both for charging and for communication between the landing platform and the UAV. In this embodiment the connectors may be standard types of connectors. Landing gears of UAVs, positioning mechanisms of landing platforms, and communication and charging connectors are means known in the field, so there is no need to describe them in detail.

Another embodiment of the present in invention refers to the above detailed embodiment that has special connectors. In this embodiment the positive outlet charging connector comprises a casing (61) that is deigned to be connected to the first or second pusher and a flexible springy conductive element (62) that is designed to be connected to the power supply source. The element is designed to be attached to the positive inlet charging connector when the first or second pusher is attached to the first or second landing gear, and the element is designed to be tightened to the positive inlet charging connector due to the springiness and the flexibility of the element. The same is applied to the negative outlet charging connector that also comprises a casing (61) that is designed to be connected to the first or second pusher and a flexible springy conductive element (62) that is designed to be connected to the power supply source. This element is designed to be attached to the negative inlet charging connector when the first or second pusher is attached to the first or second landing gear. The element is designed to be tightened to the negative inlet charging connector due to the springiness and the flexibility of the element.

From the attached drawings it is illustrated that when the element is adjacent to the inlet charging connector (positive or negative), then the spring force FX of the element itself in the X direction as shown in the drawings causes the element to tighten to the inlet connector and creates a better electrical connection. Also, as can be seen from the illustrative depiction of FIG. 9B, since the element itself is flexible, then the part of the element that touches the inlet connector takes the shape of the inlet connector and creates a larger contact area. The shape of the inlet connectors can be rounded or flat.

The outlet communication connector comprises a casing (63) that is deigned to be connected to the pusher, a set of pins (64) that are designed to be connected to the computing unit of the landing platform, and one or more magnets (65). The structure of the set of pins and the magnets can be as the standard types of this mean, that usually have two magnets. The set of pins and the one or more magnets are connected to the casing of the outlet communication connector by springy flexible connection achieved by two or more springs (66). When the pusher is attached to the landing gear the set of pins are designed to be inserted into corresponding holes (67) in the inlet communication connector and the one or more magnets are designed to be attached to one or more corresponding magnets (68) on the inlet communication connector. The structure of the inlet communication connector can be as the standard types of this mean too. The springy flexible connection of the set of pins enables a precise insertion of the set of pins to the corresponding holes of the inlet communication connector.

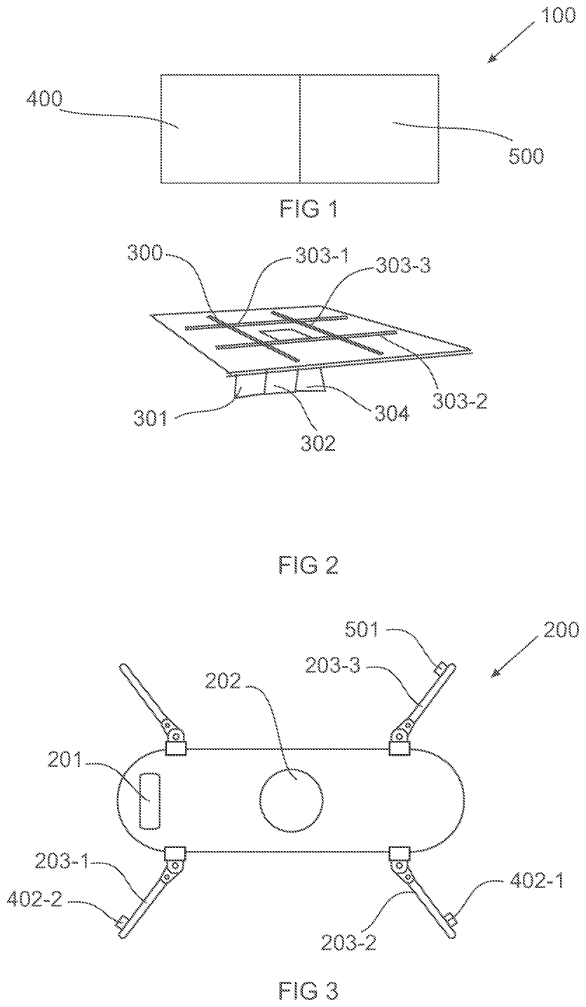

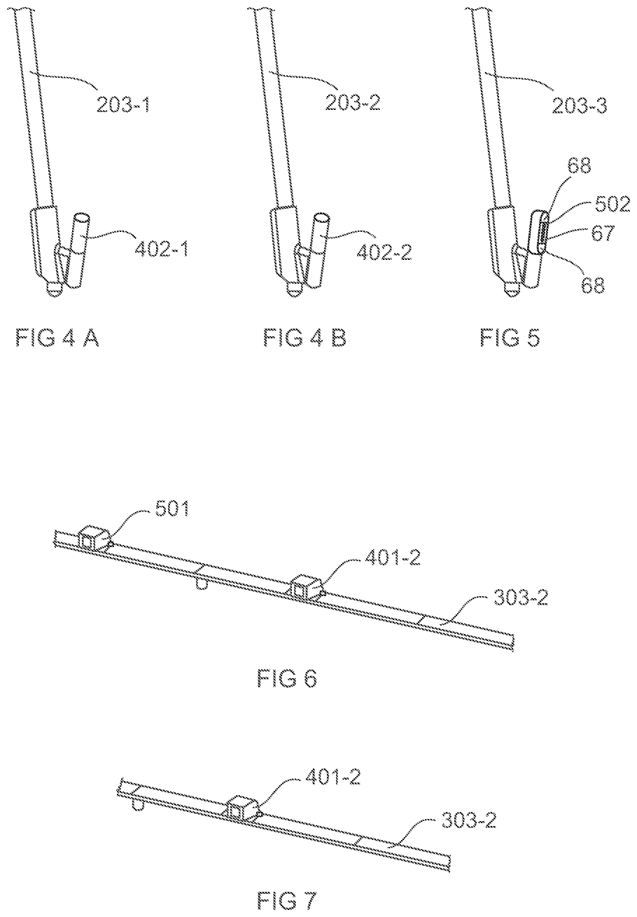

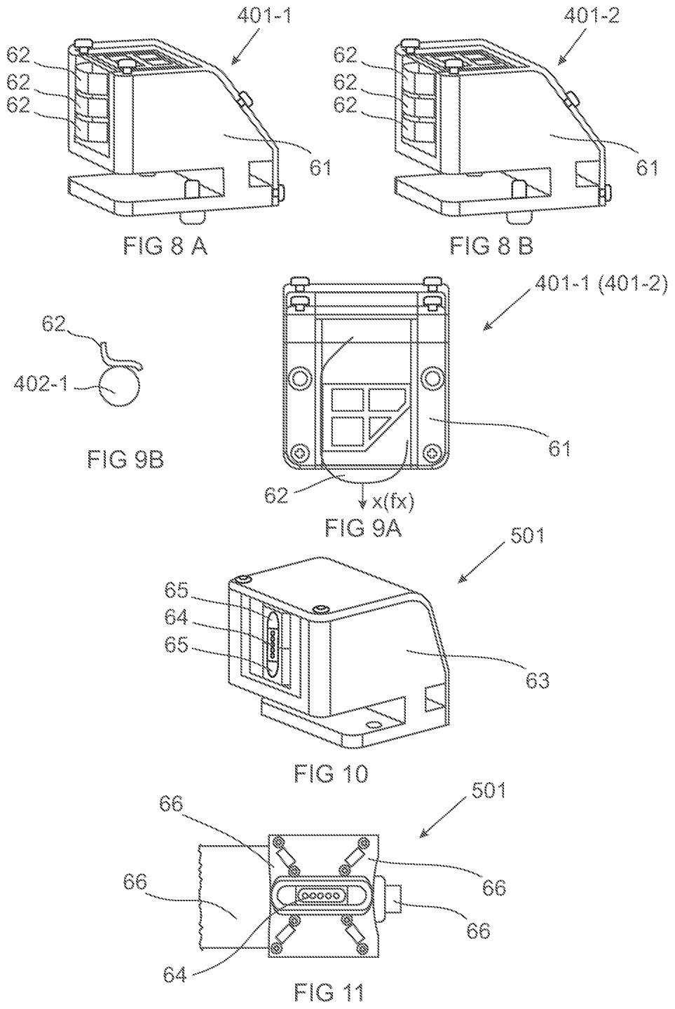

FIG. 1 is a schematic illustration of the charging and communication system (100) that comprises the charging system (400) and the communication system (500). FIG. 2 depicts the landing platform (300). FIG. 3 depicts the UAV. FIGS. 4A and 4B depict the landing gears (203-1) (203-2) with the inlet charging connectors (402-1) (402-2). FIG. 5 depicts the landing gear (203-3) with the inlet communication connector (502). FIGS. 6 and 7 depict the pushers. FIGS. 8A and 8B are a perspective depiction of the positive and negative outlet charging connectors. FIG. 9A is a top view depiction of the outlet charging connector. FIG. 9B is a schematic illustration of the part of the element that touches the inlet connector. FIG. 10 is a perspective depiction of the outlet communication connector. FIG. 11 is a depiction of the outlet communication connector with four springs (66).

The present invention also refers to a method for establishing a wired connection for transmitting video over Ethernet communication between the controller of the unmanned aerial vehicle UAV to the computing unit of the landing platform.

Today, there are no methods that allow fast communication from the aforementioned type for the transfer of video files over Ethernet technology, for example in a wired connection between a UAV and a landing pad and, in fact, to the command center. This is mainly necessary for protected transfer (and therefore wired and not wirelesses) for example in the case of military UAVs. The method described above and below enables communication as mentioned hence its uniqueness. The method comprises the following means and steps:
Provide the landing platform that is equipped with the positioning mechanism.
Provide the inlet communication connector.
Assemble the inlet communication connector on the landing gear of the UAV.
Provide the outlet communication connector that corresponds with the outlet communication connector.
Assemble the outlet communication connector on the pusher of the positioning mechanism of the landing platform
The positioning mechanism is designed to position the UAV on the landing platform in the predetermined position in such position that the outlet communication connector is adjacent and connect to the inlet communication connector.

What is claimed is:

1. A charging and communication system between an unmanned aerial vehicle UAV to a landing platform, comprising:
a charging system that is designed to charge a battery of the UAV by a power supply source, and a communication system that is deigned to electrically connect a computing unit in the landing platform with a controller of the UAV,
wherein the charging system comprises a positive outlet charging connector, a negative outlet charging connector, a positive inlet charging connector, a negative outlet charging connector; wherein the positive outlet charging connector corresponds with the positive inlet charging connector and the negative outlet charging connector corresponds with the negative inlet charging connector; wherein the positive inlet charging connector is assembled on a first landing gear of the UAV and the negative inlet charging connector is assembled on the first landing gear or on a second landing gear of the UAV; wherein the positive outlet charging connector is assembled on a first pusher of a positioning mechanism of the landing platform and the negative outlet charging connector is assembled on the first pusher or on a second pusher of the positioning mechanism;
wherein the communication system comprises an outlet communication connector and an inlet communication connector; wherein the outlet communication connector corresponds with the inlet communication connector; wherein the inlet communication connector is assembled on a landing gear of the UAV and the outlet communication connector is assembled on a pusher of a positioning mechanism;
wherein when the UAV is positioned on the landing platform in a predetermined position by the positioning mechanism, the positive outlet charging connector is adjacent to the positive inlet charging connector, the negative outlet charging connector is adjacent to the negative inlet charging connector, and the outlet communication connector is adjacent to the inlet communication connector.

2. The charging and communication system of claim 1,
wherein said positive outlet charging connector comprises a casing that is deigned to be connected to said first or second pusher and a flexible springy conductive element that is designed to be connected to said power supply source, wherein the element is designed to be attached to the positive inlet charging connector when said first or second pusher is attached to said first or second landing gear, and wherein the element is designed to be tightened to the positive inlet charging connector due to the springiness and the flexibility of the element;
wherein said negative outlet charging connector comprises a casing that is designed to be connected to said first or second pusher and a flexible springy conductive element that is designed to be connected to said power supply source, wherein the element is designed to be attached to the negative inlet charging connector when said first or second pusher is attached to said first or second landing gear, and wherein the element is designed to be tightened to the negative inlet charging connector due to the springiness and the flexibility of the element;
wherein said outlet communication connector comprises a casing that is deigned to be connected to said pusher, a set of pins that are designed to be connected to said computing unit, and one or more magnets; wherein the set of pins and the one or more magnets are connected to the casing of the outlet communication connector by springy flexible connection achieved by two or more springs; wherein when said pusher is attached to said landing gear the set of pins are designed to be inserted into corresponding holes in said inlet communication connector and the one or more magnets are designed to be attached to one or more corresponding magnets on the inlet communication connector; and wherein said springy flexible connection of the set of pins enables precise insertion of the set of pins to the corresponding holes of the inlet communication connector.

3. A method for establishing a wired connection for transmitting video over Ethernet communication between a controller of an unmanned aerial vehicle UAV to a computing unit of a landing platform, said method comprising:
providing the landing platform that is equipped with a positioning mechanism;
providing an inlet communication connector;
assembling the inlet communication connector on a landing gear of said UAV;
providing an outlet communication connector that corresponds with the outlet communication connector;
assembling the outlet communication connector on a pusher of the positioning mechanism of the landing platform;
wherein the positioning mechanism is designed to position the UAV on the landing platform in a predetermined position in such position that the outlet communication connector is adjacent and connect to the inlet communication connector;
wherein said outlet communication connector comprises a casing that is deigned to be connected to said pusher, a set of pins that are designed to be connected to said computing unit, and one or more magnets;
wherein the set of pins and the one or more magnets are designed to be connected to the casing of the outlet communication connector by springy flexible connection achieved by two or more springs;
wherein when said pusher is attached to said landing gear the set of pins are designed to be inserted into corresponding holes in said inlet communication connector and the one or more magnets are designed to be attached to one or more corresponding magnets on the inlet communication connector; and
wherein said springy flexible connection of the set of pins enables precise insertion of the set of pins to the corresponding holes of the inlet communication connector.
